(19) United States
(12) Patent Application Publication
(10) Pub. No.: US 2002/0117824 A1
(43) Pub. Date: Aug. 29, 2002

(54) Detachable interchangeable skateboard

(76) Inventor: Alonzo Edward Godfrey, Las Vegas, NV (US)

Correspondence Address: Edward Godfrey, 29 N. 28th Street, Las Vegas, NV, 89101, US

(21) Appl. No.: 10/032,904

(22) Filed: Oct. 19, 2001

Related U.S. Application Data
(63) Continuation-in-part of application No. 09/439,182, filed on Nov. 12, 1999, now abandoned.

(51) Int. Cl. B62M 1/00

(52) U.S. Cl. 280/87.05

(57) ABSTRACT

The evolution of this vehicle makes this a new form of skateboard that can be broken down into two parts to be carried with ease. The upper platform can be removed and substituted for another; this allows the rider to replace worn parts for another such as the upper platform. Once the rider places the upper-platform on top of the lowerplatform, the halves slide into the (H) shapelocking brace. Once the halves are fully secure a holding fastener locks the halves so no movement is allowed.

### BACKGROUND OF THE INVENTION

1. Field of the Invention

This invention relates to an improved and new form of skateboard and has the ability to let the skateboard rider detach the skateboard so it can be carried with ease. It allows worn parts to be replaced without having to buy a hold new skateboard. The skateboard consist of an H shape-locking brace --, upper platforms, two half, with rubber boarder on each end.

2. Description of the Related Art

U.S. Pat. No. 5,40,455 has a prior device, which is comprised of a metal spring when rider gets on the skateboard and allows board to bend and return to original form. The major draw back to such a skateboard is that it's to bulky; for all those who commute with their skateboard for school, work, and any other place. Its awkward shape causes problems for placement.

### DETAILED DESCRIPTION OF INVENTION

The H-shaped locking brace unites all components. One of the most unique concepts of this invention is the upper platform 14 and 16. These replaceable platforms allow the skateboard 10 the ability to change its look, as well as being able to replace a worn part. The holding fastener 18 plays a big hand in uniting the components that make up the skateboard 10. The holding fastener, which has an extended prong, is placed on top the H-shaped locking brace 12. The prong extends through the upper platforms 14 and 16 and the lower platforms 24 and 26. The two lower platform halves 24 and 26 have wheel assemblies 28 and 30 attached.

### DETAILED DESCRIPTION OF INVENTION

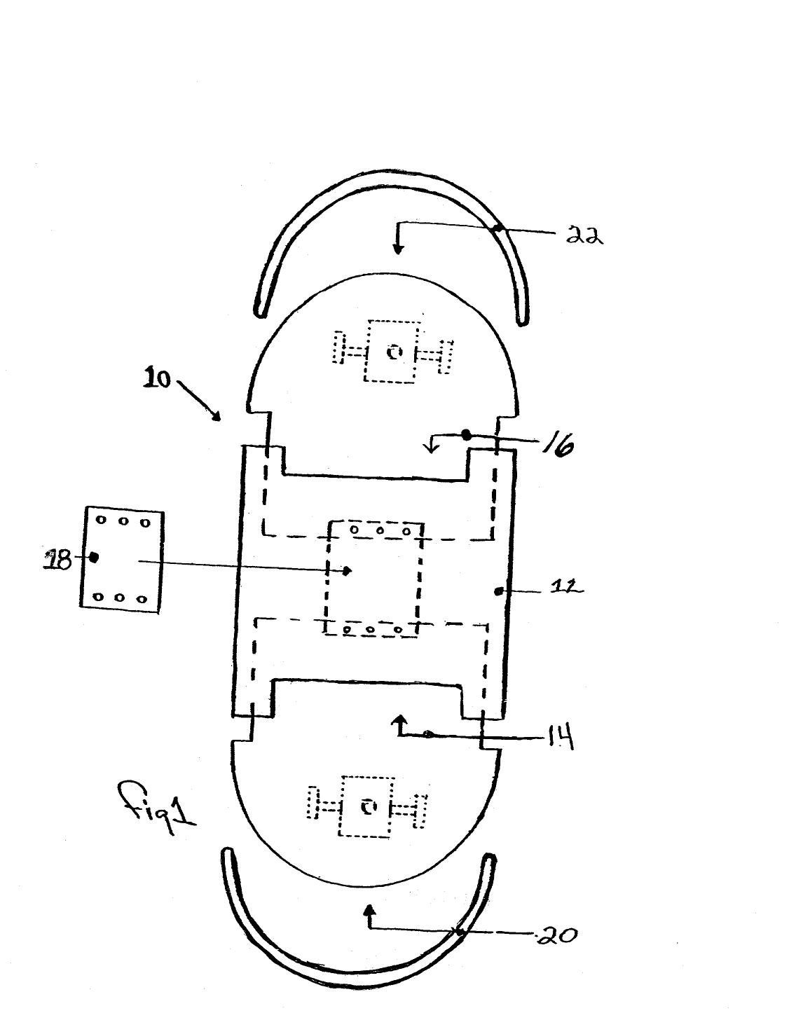

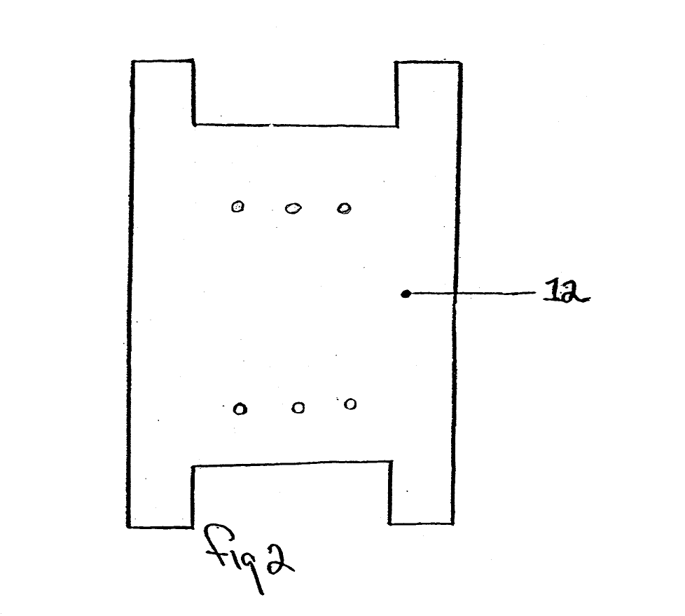

In FIG. 1, the Number 10 designates the new detachable interchangeable skateboard.

In this view the skateboard, which is composed of:

12: H-shaped locking brace

14 and 16: two upper platforms

20 and 22: rubber borders

24 and 26: two lower platforms (not seen)

28 and 30: wheel assembly

18: a holding fastener

all of which make up this unique device.

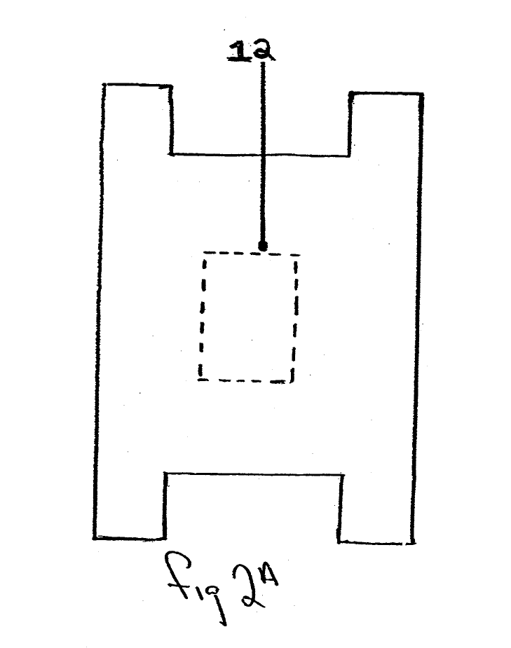

On each end of the skateboard halves there are rubber borders 20 and 22. Components 14 and 16 (upper platforms) are placed on top of 24 and 26 (lower platforms). Once this is done, the process of inserting them in must take place. The hollow H-shaped locking brace 12 has components 14, 16, 24, and 26 inserted into it. Once fully inserted, the components start to form a unique riding device. The holding fastener 18 is placed in the middle of the H-shaped locking braces 12, which holds all components in a sturdy manner. In FIG. 2, a sole view of the H-shaped locking brace 12 is seen. This device is the heart of the skateboard 10.

### BRIEF DESCRIPTION OF DRAWING

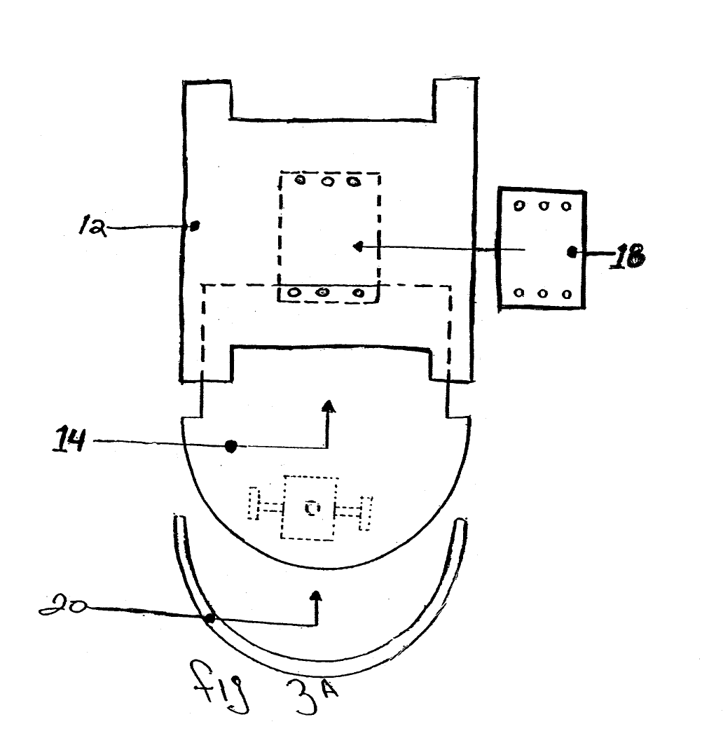

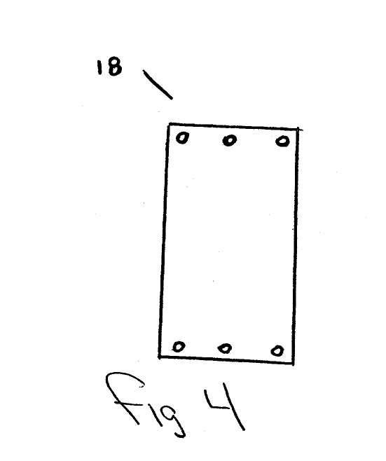

In FIG. 4: A perspective view of the holding fastener 18 is shown from a top view.

In FIG. 4A: A side view of the holding fastener 18 is shown.

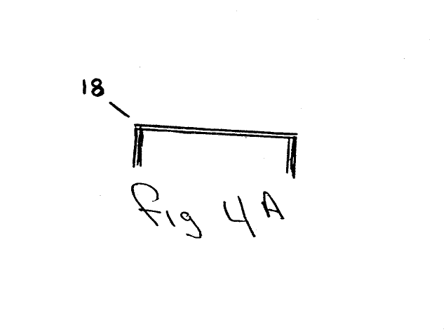

In FIG. 5: Upper platform is shown from a top view.

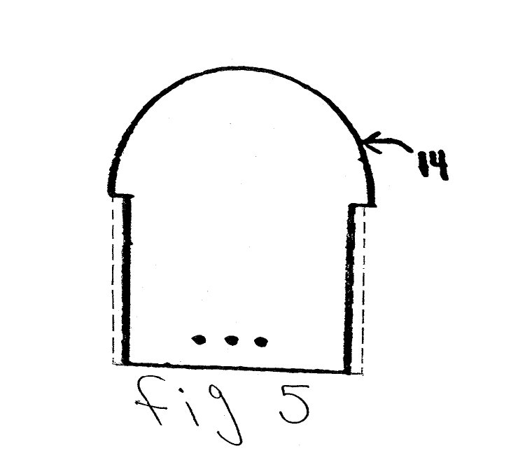

In FIG. 6: Rubber border is shown from a top view.

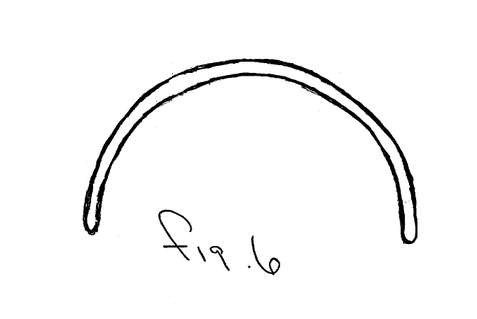

In FIG. 7: A side view of the lower platform and wheel assembly is shown. with upper platform and holding fastner.

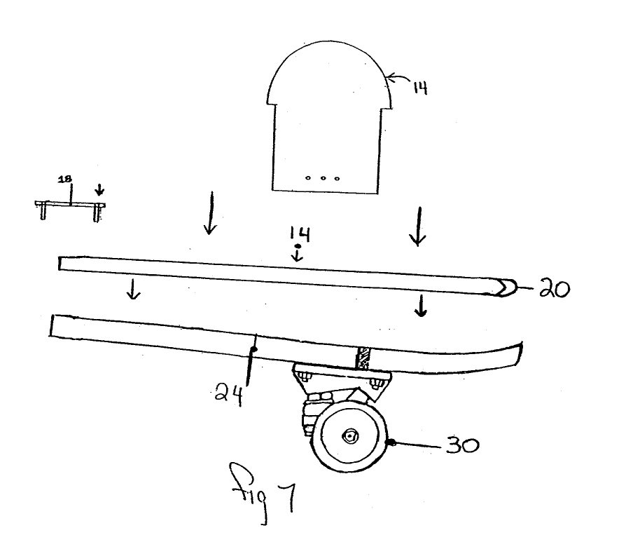

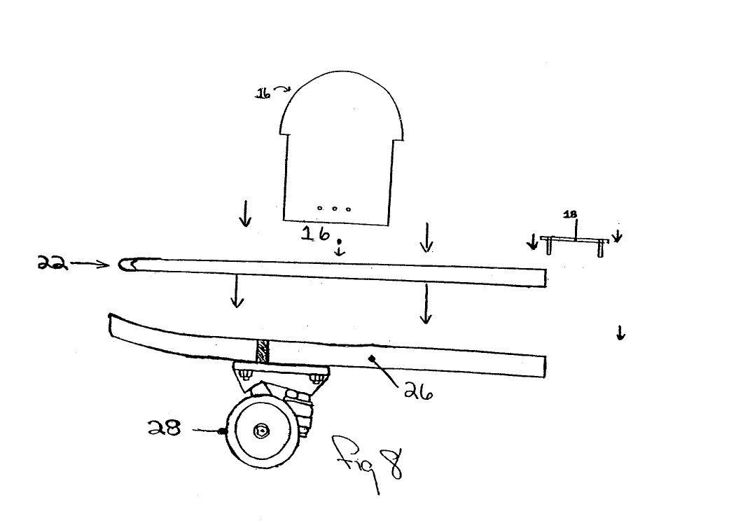

In FIG. 8: A left-hand side view of the lower platform and wheel assembly is shown. with upper platform and holding

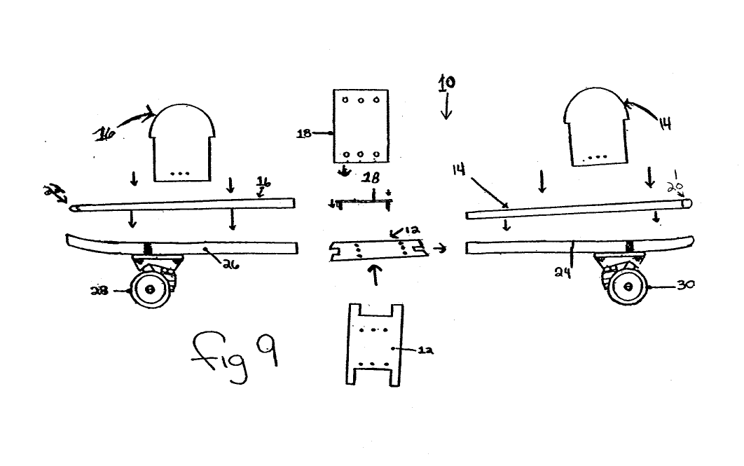

In FIG. 9: A disassemble side view of whole skateboard is shown.

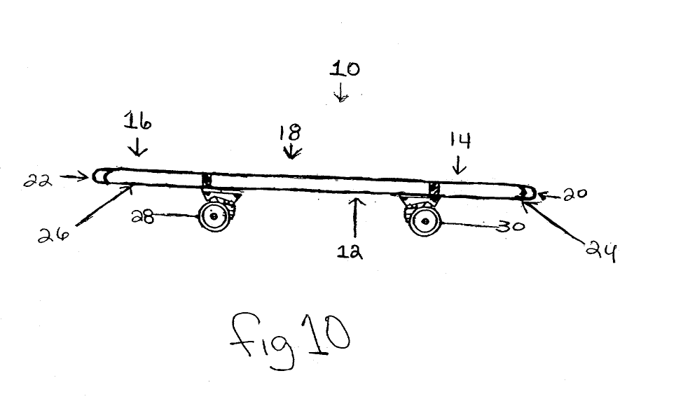

In FIG. 10: A side view of whole skateboard is shown.

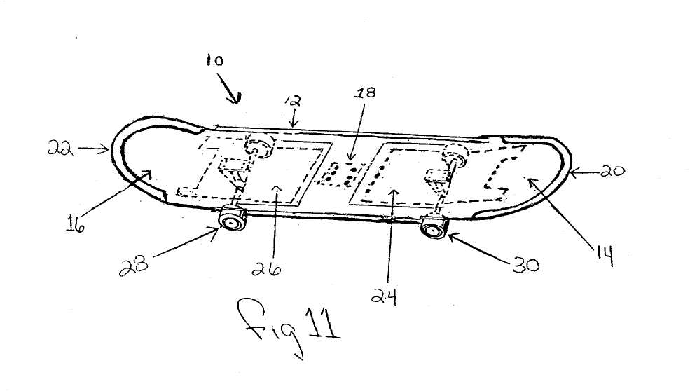

In FIG. 11: A assemble whole view of skateboard is shown from atop view.

In FIG. 1: An illustrated view of the skateboard. There is a perspective view of the detachable interchangeable skateboard, which is made up of ten components. Components 24, 26, 28, and 30 are not seen.

In FIG. 2: The H-shaped brace is seen in the front top view.

In FIG. 2A: The H-shaped brace is seen in an upside-down view, showing the bottom of the brace.

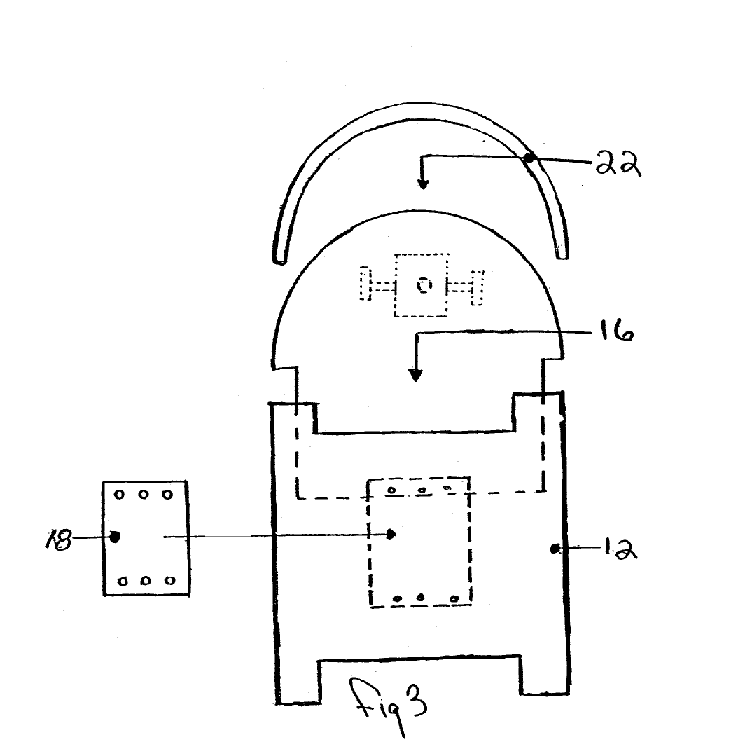

In FIG. 3: The skateboard is seen half-connected. This will give an understanding view of how the device works. Components 14, 20, 24, 26, 28, and 30 are not seen.

In FIG. 3A: The skateboard is seen half connected again, but components 16, 22, 24, 26, 28, and 30 are not seen.

### SUMMARY OF INVENTION

The skateboard that I've created is far different than that of any skateboard ever invented; I've made it to be detachable so the user can carry it with ease. The two half of the skateboard slides into the H shape brace. Once the half are secure in the brace a holding fastener holds the two half so no movement is allowed. It also has the ability to have it upper platform changed. This gives a variety of different looks as well as being able to change worn parts. Rubber boarders are attached at each and of the half of the skateboard to allow less damage like chipping, this will give skateboard longevity.

I claim:

1. A detachable skateboard for a rider to commute from Point A to Point B comprising: Upperplatform, lowerplatform, Hshape locking brace, holdingfastner, wheelassemblies and rubberborders

2. A detachable skateboard comprising: upper platforms, which mounts on top of lower platforms in which both are inserted into H shape lockingbrace, lower platforms have wheel assemblies mounted on the bottom of them, and rubber borders at each end;

3. A detachable skateboard comprising; the upper platforms claim 1 a means to enable the skateboard rider the ability to replace worn platforms the said upperplatforms can be switched from either side of said skateboard to give said skateboaed a differerent look;

4. The lower platforms claim 1 a means to enable the upper platform a strong solid base to rest upon said lower platform has wheel assemblie mount on bottom;

5. The Hshape locking brace claim i a means for holding both upper and lowerplatforms together once mounted upon one another;

6. The holding fastner claim 1 a means for keeping all components secure so no movement is allowed holding fastner fits in platform like pegs;

7. The rubber borders claim 1 a means for long evity these borders are placed at the ends of lower platforms to prevent wear and tear of said skateboard;
